(19) United States
(12) Patent Application Publication
(10) Pub. No.: US 2016/0225022 A1
(43) Pub. Date: Aug. 4, 2016

(54) METHOD TO STOP SERVING RE-TARGETING ADS TO A CONSUMER BY LEVERAGING A PURCHASE SIGNAL FROM TRANSACTION DATA

(71) Applicant: MasterCard International Incorporated, Purchase, NY (US)

(72) Inventors: Kaushal Kurapati, Cupertino, CA (US); John Michael Thornton, Palo Alto, CA (US)

(21) Appl. No.: 14/614,287

(22) Filed: Feb. 4, 2015

(51) Int. Cl. G06Q 30/02; G06F 17/30; H04L 29/08

(52) U.S. Cl. CPC G06Q 30/0255; H04L 67/02; G06F 17/3089

(57) ABSTRACT

The disclosure herein concerns facilitating a transaction for a user, storing information about the nature of the transaction on a financial institution server, generating a stop targeting cookie based on the nature of the transaction, and placing the stop targeting cookie on a user's browser. The disclosure also concerns utilizing an electronic data structure representing the content of a transaction by a user of an electronic commerce site from a financial institution server that facilitated the transaction. The ad targeting server compares the transaction content information in the electronic data structure to the re-targeting cookie, and if the at least one re-targeting cookie matches the transaction information, the ad targeting server at least one of deletes, updates, and replaces the re-targeting cookie.

### BACKGROUND

1. Field

This disclosure relates to computer systems and related methods that are adapted to facilitate automated targeting of advertising content and more particularly to systems and methods to stop serving ads to a consumer in certain circumstances based on detecting a purchase signal from transaction data at a computer server of a transaction enabling party, such as a financial institution.

2. Description of the Related Art

In embodiments, targeting of advertisements on the Internet typically may involve a user browsing products on an e-commerce site, optionally placing one or more products in an electronic shopping cart, wish list, or the like, but then leaving the site without completing a purchase. The host of the e-commerce site may work with an ad targeting network, which may put a cookie or other tracking element on the user's browser when the user was on the e-commerce site. In a process referred to herein as re-targeting, as the user continues to browse the Web, the previously browsed/abandoned products may be the subject of targeted messages, reminders, or “ads,” on various Internet sites, such as ones that participate with the same ad targeting network as the e-commerce site that was initially browsed. These ‘ads’ are supposed to remind the user again and again that the user has an incomplete purchase pending at the e-commerce site and enable the user to return to the e-commerce site, such as via a click on the ad, to complete the purchase. When the user returns to the site to make the purchase, the re-targeted ad has served its purpose.

The downside with this typical process is that many times users browse many sites for products and end-up purchasing from one place, while hosts of all the other sites that the user abandoned (did not buy from) may continue expending resources with re-targeted ads that are no longer relevant. This may be a pure waste of their ad budgets because they do not know that the user has already purchased the product. This is also a waste of ad inventory for the publisher, as they could use the publisher ad space to serve a more relevant ad.

A need exists for methods and systems that reduce the waste of re-targeting resources after a user has made a purchase.

### SUMMARY

Provided herein are methods and systems that indicate to ad networks that a user has already purchased a product to help sites stop targeting or retargeting ads for the purchased product. A financial institution or other party that facilitates a transaction may provide information about the transaction for a stop re-targeting cookie, where the stop re-targeting cookie, when detected, such as by a server of an advertising network interacting with a user's browser, prompts a comparison to a re-targeting cookie on the browser and, if the stop re-targeting cookie and the re-targeting cookie are matched, may prompt the modification, removal, or replacement of the re-targeting cookie.

In an aspect, a method to stop serving re-targeting ads or to modify targeting of ads includes facilitating a transaction for a user, storing information about the nature of the transaction on a financial institution server, generating a stop targeting cookie based on the nature of the transaction, and placing the stop targeting cookie on a user's browser. The stop targeting cookie may be a stop re-targeting cookie. When an ad network server is contacted for an ad to place on the user's browser, the stop re-targeting cookie is compared to a re-targeting cookie, and the ad network server is caused to not place an ad on the user's browser when the re-targeting cookie and the stop re-targeting cookie are matched based on the comparison. The match may be based on: the re-targeting cookie and the stop re-targeting cookie relating to the same product or service, the re-targeting cookie and the stop re-targeting cookie relating to similar products or services, or a merchant can set preferences as to what extent of matching information is sufficient to cause an ad network server to not place an ad on the user's browser. The information may be at least one of a category of item, the actual item, provider, merchant, category of merchant, SKU, QR code, bar code, part number, and serial number. The stop re-targeting cookie may be compared to a re-targeting cookie for matching information in a time span shorter than a browser refresh or webpage load. The stop re-targeting cookie may be compared to a re-targeting cookie in a time span selected from the group consisting of: less than about 10 seconds, less than about 5 seconds, less than about 1 second, or substantially instantaneously. The transaction may be facilitated on an online store, a physical store, on a mobile app, by mail, or by phone. A merchant may set preferences as to if a stop re-targeting cookie can be accessed by the ad network server based on a level of a purchase intent of the user.

In an aspect, a method to stop serving re-targeting ads or modify targeting includes taking at an ad targeting server, an electronic data structure representing the content of a transaction by a user of an electronic commerce site from a financial institution server that facilitated the transaction, accessing, by the ad targeting server, at least one re-targeting cookie from a user's browser, comparing the transaction content information to the re-targeting cookie for matching or overlapping information 210, and if the at least one re-targeting cookie matches the transaction content information, at least one of deleting, updating, or replacing the re-targeting cookie. A merchant can set preferences as to what extent of matching information is sufficient to cause the deleting, updating, or replacing of the re-targeting cookie. The transaction content information may be at least one of the following: a category of item, an identifier of the actual item, a provider identifier, a merchant identifier, a category of merchant, a SKU, a QR code, a bar code, a part number, and a serial number. The transaction content information may be compared to a re-targeting cookie in a time span shorter than a browser refresh or webpage load. The transaction content information may be compared to a re-targeting cookie in a time span selected from the group consisting of: less than about 10 seconds, less than about 5 seconds, less than about 1 second, or substantially instantaneously. The transaction may be facilitated on an online store, a physical store, on a mobile app, by mail, or by phone. A merchant interacting with the ad targeting server may set preferences as to whether a stop re-targeting cookie can be at least one of deleted, updated, and replaced based on a detected level of a purchase intent of the user.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clarified by the text. Grammatical conjunctions are intended to express any and all disjunctive and conjunctive combinations of conjoined clauses, sentences, words, and the like, unless otherwise stated or made clear by the context.

### BRIEF DESCRIPTION OF THE FIGURES

The invention and the following detailed description of certain embodiments thereof may be understood by reference to the following figures:

FIG. 1 depicts a method to stop serving re-targeting ads.

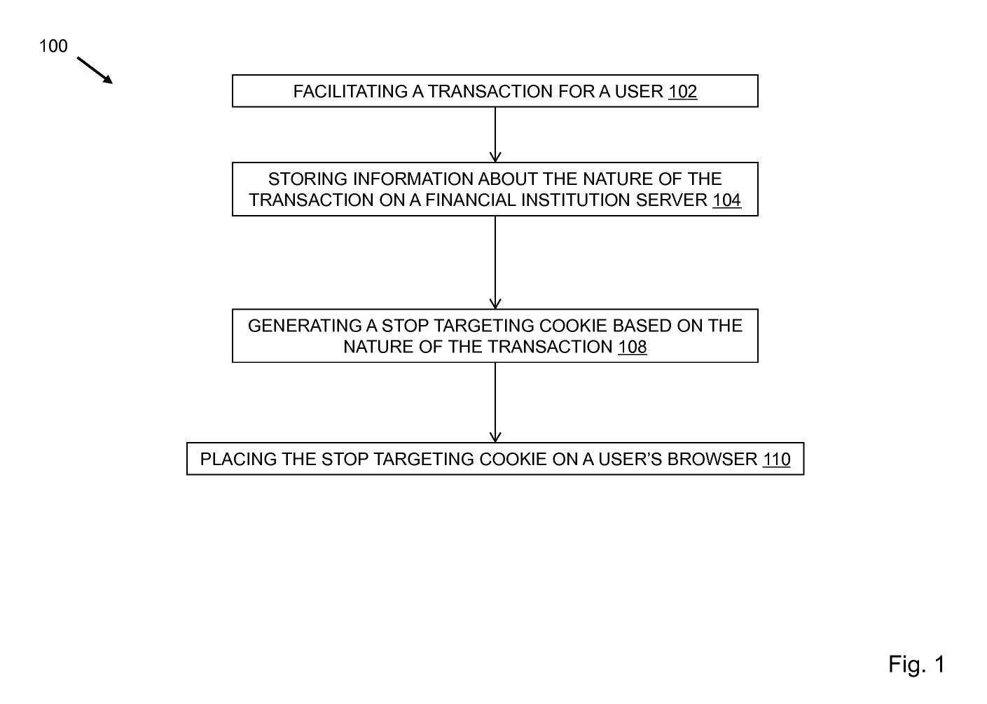

FIG. 2 depicts a method to stop serving re-targeting ads.

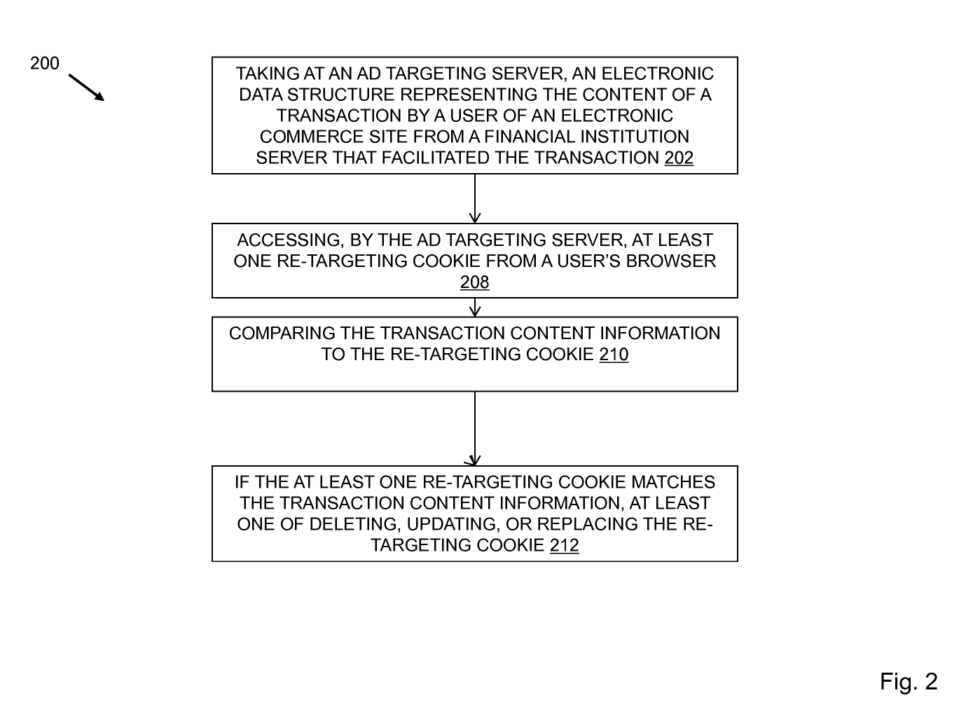

### DETAILED DESCRIPTION

In embodiments, as users browse goods or services on an e-commerce site and optionally place one or more goods or services in an electronic shopping cart, on a wish list, or the like, a cookie may be placed on the user's browser. The user may leave the site without completing a purchase, and the cookie may signal the ad network to place an ad, message, or the like corresponding to the browsed goods or services on a publisher site visited by the user. The ad or message may be placed even if the goods or services were purchased at the original e-commerce site or with another merchant or site. In some embodiments, re-targeting is accomplished by placing code, such as a JavaScript tag, in a portion of the e-commerce website, such as a footer or header. This code creates a list of users, or user identifiers, that visit the site by placing “cookies” in each user's browser. This list allows an ad network or targeting vendor to display targeted ads to users as they visit other sites, which, when targeting users who have already undertaken actions with respect to particular goods, such as placing the goods in a shopping cart or on a wish list, can be referred to as “re-targeting” the users, due to the repeated nature of the targeting for those users.

In the present disclosure, a system to signal to the ad network that one or more browsed goods or services have been purchased or otherwise transacted upon at a similar merchant is described. One component of the system relies on obtaining information that a good or service or a similar good or service has been purchased at a different site, or that a user has purchased some good or service, even if it is not the same browsed good or service, from a similar merchant. In one preferred embodiment, if a user purchases an item in a transaction with one merchant that places ads with an ad network, the signal can be delivered or found by that merchant and other merchants that work with the ad network, so that the fact that the user has purchased the item is known throughout the set of merchants that work with the ad network.

In an embodiment, in one scenario, a financial institution that facilitated a purchase or transaction may have information about the good or service associated with the transaction, such as the category of item, the identity of the actual item, the identity of the provider, the identity of the merchant, a merchant category, a SKU, a QR code, a bar code, a part number, a serial number, or the like. For example, a user may browse a first sneaker at a first online shoe store. The user may leave the first online shoe store without completing the purchase, but then may go to a second online shoe store. In this example, the user purchases the first sneaker at the second online shoe store and the financial institution facilitates the transaction. The financial institution now possesses information about this transaction. For example, the financial institution may know the category of items purchased by the user (sneakers/shoes, in this example), the actual item (the first sneaker, in this example), the exact merchant/website where the transaction took place (the second online shoe store, in this example), the category of merchant/website where the transaction took place, certain details about the item (e.g. bar code, SKU, QR code, etc.), and the like. While this example uses a second online store as the eventual merchant/website where the transaction took place, it should be understood that this system is operable where the transaction eventually takes place at any online or physical store for which the financial institution facilitates transactions, such as by processing credit card purchases.

Since the financial institution possesses information about the transaction once it occurs, in embodiments the financial institution may signal to the ad network that the user has already purchased the same or similar goods or services, or that the user has made a purchase with a similar merchant or service provider. The signal may include one or more pieces of information about the transaction of the types noted above.

In one example, the signal may be a cookie that the financial institution places on the user's browser, or hands off to an ad network to place on the user's browser, that indicates that targeting should stop or be modified with respect to the goods or services in question. Such a signal is referred to throughout this disclosure as a “stop re-targeting” cookie or a “stop re-targeting” signal, and it should be understood that except where context indicates otherwise, such a signal or cookie should be understood to encompass signals to stop re-targeting altogether, to modify the nature of targeting, or to substitute a different kind of targeting. The stop re-targeting cookie may include information about the transaction. Continuing with the example of the first sneaker purchase, the stop re-targeting cookie may include information about the user making a purchase at the second online shoe store, such as the actual name of the store, the category of merchant, or the like. Now, when the user browses to a new webpage or a current webpage is refreshed, the ad network server is contacted for an ad to place on the page. The ad network server may access cookies on the user's browser, including at least one from the first online shoe store and the stop re-targeting cookie. The cookies may be compared to determine whether they match, such as based on identical, overlapping or similar information, which in this case is a category of merchant, and the stop re-targeting cookie that is based on the financial institution's transaction information may be recognized as a signal to stop or modify re-targeting (that is, it is recognized as a stop re-targeting cookie) because of the match of information between the two types of cookie. Having recognized the stop re-targeting cookie, the ad network server will be caused to undertake a different action than it would have otherwise taken absent the matching of the stop re-targeting cookie with the conventional cookie, such as not placing an ad associated with the first online shoe store on the web page, placing a modified ad (such as for a different item), deleting the conventional cookie, or the like. In embodiments, the process of comparing cookies for matching or overlapping information may occur automatically, under computer control of the ad targeting server or other server, in a time span shorter than a browser refresh or webpage load such that a re-targeted ad can be blocked from being displayed when a new ad is requested from the ad server. This time span may less than about 10 seconds, less than about 5 seconds, less than about 1 second, or substantially instantaneously.

In an embodiment, a method to stop serving re-targeting ads 100 or to modify targeting of ads includes facilitating a transaction for a user 102, storing information about the nature of the transaction on a financial institution server 104, generating a stop targeting cookie based on the nature of the transaction 108, and placing the stop targeting cookie on a user's browser 110. The stop targeting cookie may be a stop re-targeting cookie. When an ad network server is contacted for an ad to place on the user's browser, the stop re-targeting cookie is compared to a re-targeting cookie, and the ad network server is caused to not place an ad on the user's browser when the re-targeting cookie and the stop re-targeting cookie are matched based on the comparison. The match may be based on: the re-targeting cookie and the stop re-targeting cookie relating to the same product or service, the re-targeting cookie and the stop re-targeting cookie relating to similar products or services, or a merchant can set preferences as to what extent of matching information is sufficient to cause an ad network server to not place an ad on the user's browser. The information may be at least one of a category of item, the actual item, provider, merchant, category of merchant, SKU, QR code, bar code, part number, and serial number. The stop re-targeting cookie may be compared to a re-targeting cookie for matching information in a time span shorter than a browser refresh or webpage load. The stop re-targeting cookie may be compared to a re-targeting cookie in a time span selected from the group consisting of: less than about 10 seconds, less than about 5 seconds, less than about 1 second, or substantially instantaneously. The transaction may be facilitated on an online store, a physical store, on a mobile app, by mail, or by phone. A merchant may set preferences as to if a stop re-targeting cookie can be accessed by the ad network server based on a level of a purchase intent of the user.

In another version of this example, the stop re-targeting cookie may include information about the item purchased, such as the name of the item, a SKU, or the like. Now, when the user browses to a new webpage or a current webpage is refreshed, the ad network server is contacted for an ad to place on the page. The ad network server may access cookies on the user's browser, including at least one from the first online shoe store and the stop re-targeting cookie. The cookies may be compared for a match, such as based on similar or overlapping information, which in this case is information about an item, and the cookie that is based on the financial institution's information about the content of a transaction may be recognized as a stop re-targeting cookie because of the matching or overlapping information. Having recognized the stop re-targeting cookie, the ad network server will be caused to not place the ad associated with the first online shoe store that would have been placed if the ad network server only detected a conventional cookie; instead, the ad network server may place no advertisement, or it may place a modified advertisement. In embodiments, the process of comparing cookies for matching or overlapping information may occur automatically, under computer control, in a time span shorter than a browser refresh or webpage load such that a re-targeted ad can be blocked from being displayed when a new ad is requested from the ad server. This time span may less than about 10 seconds, less than about 5 seconds, less than about 1 second, or substantially instantaneously.

In an embodiment, a method to stop serving re-targeting ads 200 or modify targeting includes taking at an ad targeting server, an electronic data structure representing the content of a transaction by a user of an electronic commerce site from a financial institution server that facilitated the transaction 202, accessing, by the ad targeting server, at least one re-targeting cookie from a user's browser 208, comparing the transaction content information to the re-targeting cookie for matching or overlapping information 210, and if the at least one re-targeting cookie matches the transaction content information, at least one of deleting, updating, or replacing the re-targeting cookie 212. A merchant can set preferences as to what extent of matching information is sufficient to cause the deleting, updating, or replacing of the re-targeting cookie. The transaction content information may be at least one of a category of item, an identifier of the actual item, a provider identifier, a merchant identifier, a category of merchant, a SKU, a QR code, a bar code, a part number, and a serial number. The transaction content information may be compared to a re-targeting cookie in a time span shorter than a browser refresh or webpage load. The transaction content information may be compared to a re-targeting cookie in a time span selected from the group consisting of: less than about 10 seconds, less than about 5 seconds, less than about 1 second, or substantially instantaneously. The transaction may be facilitated on an online store, a physical store, on a mobile app, by mail, or by phone. A merchant interacting with the ad targeting server may set preferences as to whether a stop re-targeting cookie can be at least one of deleted, updated, and replaced based on a detected level of a purchase intent of the user.

While the above scenario is illustrative of at least one way for re-targeting to be stopped, there are many other ways contemplated in this disclosure, some of which may involve an ad network's preference or a merchant's preference. The ad network server or merchant can set preferences as to what information may be required to be included in the stop re-targeting cookie in order for an ad to not be placed on a user webpage. For example, the stop re-targeting cookie may include information about the specific item purchased at the second online shoe store and, in this example, perhaps the item was a second sneaker. In this example, in accordance with a merchant or ad network preference, the merchant or ad network may elect to continue placing re-targeting ads for the first sneaker or re-targeting may be stopped. In embodiments, if transaction information of the enabling financial institution indicates the occurrence of a purchase by a user of an item that was the subject of re-targeting in an ad network, the detection of a stop re-targeting cookie may prompt the delivery of a targeted ad for a complementary item. For example, if a user, after shopping for some time period, has purchased a particular smart phone, the ad network, instead of sending a message or ad that reminds the user about the smart phone, may deliver an advertisement for an accessory for the smart phone, such as a protective case, a stylus, or the like.

In an embodiment, the user may browse the first online shoe store for the first sneaker, but may then visit a physical shoe store to make the purchase of the first sneaker. Since it is the financial institution that possesses the transaction information useful for generating a stop re-targeting cookie, it does not matter if the purchase was made at an online store, a physical store, on a mobile app, by mail, by phone, or the like, so long as the financial institution can associate the transaction information with the user's browser to accurately generate a stop re-targeting cookie or signal that a stop re-targeting cookie should be generated by the ad network.

In an embodiment, an alternative way for a financial institution to signal to an ad network that re-targeting should be stopped may be by deleting, updating, or replacing the re-targeting cookie. In this embodiment, when the financial institution facilitates the transaction, instead of generating a new stop re-targeting cookie, the financial institution may simply access cookies on the user's browser, compare the transaction information to the re-targeting cookies present on the user's browser, and if there are any cookies where the re-targeting information matches or overlaps with the transaction information, the re-targeting cookie may be deleted, updated, or replaced. In embodiments, the process of deleting, updating, or replacing cookies may occur automatically under computer control in a time span shorter than a browser refresh or webpage load such that a re-targeted ad can be blocked from being displayed when a new ad is requested from the ad server. This time span may less than about 10 seconds, less than about 5 seconds, less than about 1 second, or substantially instantaneously.

In another embodiment, an alternative way for a financial institution to signal to an ad network that re-targeting should be stopped may be based on a specific purchase intent signal. For example, information about how far the user made it into the purchase transaction, such as whether an item was placed in a basket, whether a coupon code was entered, whether payment information was entered, whether an item was placed on a wish list, or any other shopping-related or purchase-related activity may be used to ascertain purchase intent, wherein the further along the user was in the transaction, the greater the likelihood that the purchase would have been completed, and thus, the higher the inferred purchase intent. Purchase intent may be a piece of information that is included in the re-targeting cookie placed by the e-commerce site and the merchant or ad network may create rules associated with the purchase intent. For example, for users with low purchase intent, any transaction at a similar merchant may be sufficient information in a stop re-targeting cookie to cause an ad network to not place an ad on a web page, or to place a different ad, in accordance with merchant preference. In another example, for users with high purchase intent, only a transaction including the exact item that was not purchased may be sufficient information in a stop re-targeting cookie to cause an ad network to not place an ad on a web page, in accordance with merchant preference.

In an embodiment, the e-commerce site may directly integrate with a payment instrument on the site, such as through use of a digital wallet. When the re-targeting cookie is generated by the e-commerce site, it may be automatically associated with the payment instrument. Then, as transactions are made using the payment instrument or digital wallet at other sites, the information on the re-targeting cookie may be deleted, updated, or replaced in response to information obtained from the payment instrument.

In embodiments, stop re-targeting cookies may be useful even if users are switching between various channels, such as browsers, platforms, devices (e.g. desktop, laptop, tablet, smartphone, cellular phone), applications, mobile applications, network types (e.g. telecommunications network, ISP), computer architectures (e.g., distributed, cloud architecture), offline merchants or service providers, and the like, when they are browsing or purchasing. For example, by matching users across devices, such as by using spatial information, temporal information, first party (e.g. voluntary identification by the user) or third party data, re-targeting campaigns can flow through multiple channels. Likewise, stop re-targeting cookies can also be useful across channels. Using the same or similar spatial information, temporal information, first party data, or third party data, stop re-targeting cookies can be placed across channels effectively.

In embodiments, stop re-targeting cookies may be useful to stop re-targeting ads from being placed on social networks (e.g. Facebook) or as promoted tweets or re-tweets on Twitter.

In embodiments, analytics may be used to track failed conversions. For example, each time a stop re-targeting cookie is matched to a re-targeting cookie, this may be tracked as a failed conversion by the ad network. Data associated with the re-targeting cookie and the stop re-targeting cookie may be analyzed to determine a pattern or cause for the failed conversion, such as different cost of the products, better assortment of variations/sizes offered, and the like.

While only a few embodiments of the present invention have been shown and described, it will be obvious to those skilled in the art that many changes and modifications may be made thereunto without departing from the spirit and scope of the present invention as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present invention may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

All documents referenced herein are hereby incorporated by reference.

What is claimed is:

1. A method, comprising:
facilitating a transaction for a user;
storing information about the nature of the transaction on a financial institution server;
generating a stop targeting cookie based on the nature of the transaction; and
placing the stop targeting cookie on a user's browser.

2. The method of claim 1, wherein the stop targeting cookie is a stop re-targeting cookie.

3. The method of claim 2, wherein when an ad network server is contacted for an ad to place on the user's browser, the stop re-targeting cookie is compared to a re-targeting cookie.

4. The method of claim 3, wherein the ad network server is caused to not place an ad on the user's browser when the re-targeting cookie and the stop re-targeting cookie are matched based on the comparison.

5. The method of claim 4, wherein the match is based on the re-targeting cookie and the stop re-targeting cookie relating to the same product or service.

6. The method of claim 4, wherein the match is based on the re-targeting cookie and the stop re-targeting cookie relating to similar products or services.

7. The method of claim 4, wherein a merchant can set preferences as to what extent of matching information is sufficient to cause an ad network server to not place an ad on the user's browser.

8. The method of claim 1, wherein the information is at least one of a category of item, the actual item, provider, merchant, category of merchant, SKU, QR code, bar code, part number, and serial number.

9. The method of claim 3, wherein the stop re-targeting cookie is compared to a re-targeting cookie for matching information in a time span shorter than a browser refresh or webpage load.

10. The method of claim 3, wherein the stop re-targeting cookie is compared to a re-targeting cookie in a time span selected from the group consisting of: less than about 10 seconds, less than about 5 seconds, less than about 1 second, or substantially instantaneously.

11. The method of claim 1, wherein the transaction is facilitated on an online store, a physical store, on a mobile app, by mail, or by phone.

12. The method of claim 2, wherein a merchant can set preferences as to if a stop re-targeting cookie can be accessed by the ad network server based on a level of a purchase intent of the user.

13. A method, comprising:
taking at an ad targeting server, an electronic data structure representing the content of a transaction by a user of an electronic commerce site from a financial institution server that facilitated the transaction;
accessing, by the ad targeting server, at least one re-targeting cookie from a user's browser;
comparing the transaction content information to the re-targeting cookie; and
if the at least one re-targeting cookie matches the transaction information, at least one of deleting, updating, and replacing the re-targeting cookie.

14. The method of claim 13, wherein a merchant can set preferences as to what extent of matching information is sufficient to cause the deleting, updating, or replacing of the re-targeting cookie.

15. The method of claim 13, wherein the transaction content information is at least one of a category of item, an identifier of the actual item, a provider identifier, a merchant identifier, a category of merchant, a SKU, a QR code, a bar code, a part number, and a serial number.

16. The method of claim 13, wherein the transaction content information is compared to a re-targeting cookie in a time span shorter than a browser refresh or webpage load.

17. The method of claim 13, wherein the transaction content information is compared to a re-targeting cookie in a time span selected from the group consisting of: less than about 10 seconds, less than about 5 seconds, less than about 1 second, or substantially instantaneously.

18. The method of claim 13, wherein the transaction is facilitated on an online store, a physical store, on a mobile app, by mail, or by phone.

19. The method of claim 13, wherein a merchant interacting with the ad targeting server can set preferences as to whether a stop re-targeting cookie can be at least one of deleted, updated, and replaced based on a detected level of a purchase intent of the user.
